(19) United States
(12) Patent Application Publication
(10) Pub. No.: US 2016/0025359 A1
(43) Pub. Date: Jan. 28, 2016

(54) AIR CONDITIONER DEBRIS CONE

(71) Applicant: SIZE REDUCTION SPECIALISTS CORP., East Lansing, MI (US)

(72) Inventor: Donald Maynard, East Lansing, MI (US)

(21) Appl. No.: 14/811,180

(22) Filed: Jul. 28, 2015

Related U.S. Application Data
(60) Provisional application No. 62/029,880, filed on Jul. 28, 2014.

(51) Int. Cl. F24F 1/58; B23P 19/00

(52) U.S. Cl. CPC F24F 1/58; B23P 19/00

(57) ABSTRACT

An air conditioning (A/C) cover is provided that includes a mesh material configured as a cone. The cone has a lower base circumference that is designed to cover an exhaust fan opening of an A/C unit. The cover can be formed from metal or plastic mesh. In some embodiments a breathable material on a frame is configured as a cone with a lower base circumference that is designed to cover an exhaust fan opening of an A/C unit. A process of protecting an exhaust fan from debris infiltration includes the provision of a flat sheet of a mesh material to an end-user with instructions how to form a cone from the mesh material and how to use fasteners to retain the shape of the cone; and coupling the cone to a housing around the exhaust fan.

### RELATED APPLICATIONS

This application is a non-provisional application that claims priority benefit of U.S. Provisional application Ser. No. 62/029,880 filed 28 Jul. 2014; the contents of which are hereby incorporated by reference.

### FIELD OF THE INVENTION

The present invention in general relates to the field of air conditioning and in particular to a debris mesh cone configured for placement above an air conditioner exhaust fan.

### BACKGROUND OF THE INVENTION

Air conditioning (A/C) units are generally exposed to the weather and other environmental elements as the A/C units are positioned outside the structure that is being cooled. The A/C unit is generally equipped with a large fan at the top to cool the unit, and the fan exhaust needs to be kept clear of debris. However, since the A/C units are positioned outside debris tend to build up such as leaves, pine needles, etc. When leaves or debris decay they give off acidic gases that eat at the A/C unit's copper tubing, and by making small holes in the tubing allow Freon to escape, causing the A/C unit compressor to fail. Furthermore, to prevent the rusting of parts moisture being trapped inside the A/C unit should be avoided. Trapped moisture is the main cause of failure to electronics, electrical connections, switches and metal parts. Therefore, it is important to extend the life of the A/C unit by covering the unit all year round, even when A/C is in use, without trapping moisture in the unit. Thus, a cover for an A/C unit needs to be breathable and not restrict airflow from the exhaust fan. FIG. 1 illustrates a flat mesh cover 10 that is attached to an A/C unit 12 over the exhaust fan 14. However, the flat nature of existing A/C unit covers allows debris to build up, become matted, and clog up the pours or mesh of the cover thereby restricting airflow and trapping moisture in the covered A/C unit.

Thus, there exists a need for an improved cover for A/C units, where the cover does not get clogged with debris.

### SUMMARY OF THE INVENTION

An air conditioning (A/C) cover is provided that includes a mesh material configured as a cone. The cone has a lower base circumference that is designed to cover an exhaust fan opening of an A/C unit. The cover is attached to the A/C unit with at least one fastener of bungee cords, an elastic band, an adjustable band clamp, snap connectors, a plunger-type retainer, or a combination thereof. The cover can be formed from metal or plastic mesh. In some embodiments a breathable material on a frame is configured as a cone with a lower base circumference that is designed to cover an exhaust fan opening of an A/C unit.

A process of protecting an exhaust fan from debris infiltration includes the provision of a flat sheet of a mesh material to an end-user with instructions how to form a cone from the mesh material and how to use fasteners to retain the shape of the cone; and coupling the cone to a housing around the exhaust fan.

### BRIEF DESCRIPTION OF THE DRAWINGS

The present invention is further detailed with respect to the following non-limiting specific embodiments of the present invention. The appended claims should not be construed as being limited to the specific devices so detailed.

FIG. 1 is a partial view of an existing flat mesh cover on an A/C unit; and

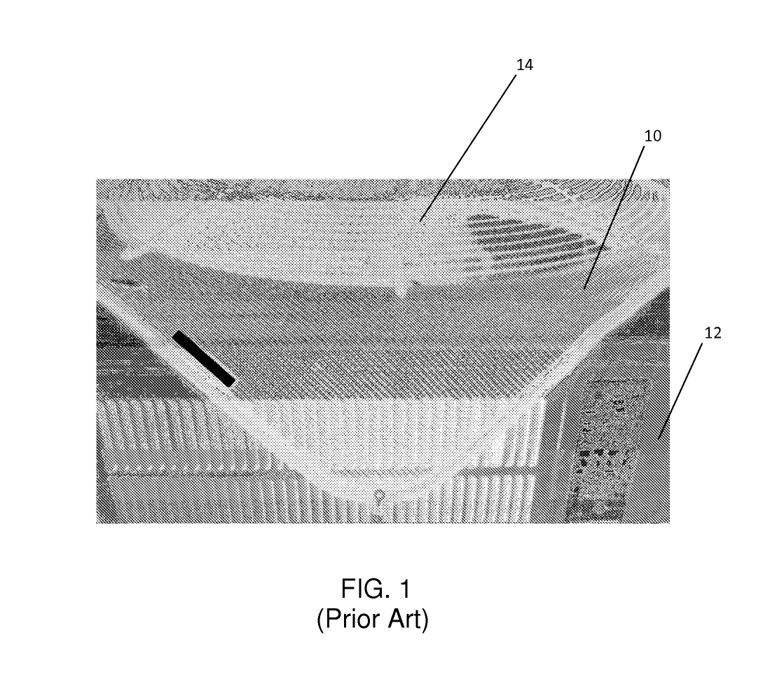

FIG. 2 is an exploded perspective view of a conical mesh cover and an A/C unit according to an embodiment of the invention; and

FIG. 3 is a prior art view of a plunger-type retainer operative in the formation or retention of an inventive cover on an A/C unit.

### DETAILED DESCRIPTION OF THE INVENTION

The present invention has utility as a cover for A/C units. Embodiments of the inventive cover prevent the buildup of debris on the units exhaust fan. The inventive cover is formed from a mesh that has a conical shape that deflects debris, and does not allow the debris to buildup on the cover. Embodiments of the inventive conical mesh cover may be formed from a metal or plastic screen material. In a separate embodiment, the inventive cover is formed from a breathable material on a conical frame. The lower circumference of the A/C cover cone is sized to cover the exhaust fan opening of the A/C unit. Embodiments of the inventive cover may be secured to an A/C unit with cable ties, twisted wire, bungee cords, an elastic band, an adjustable band clamp, snap connectors, or a combination thereof

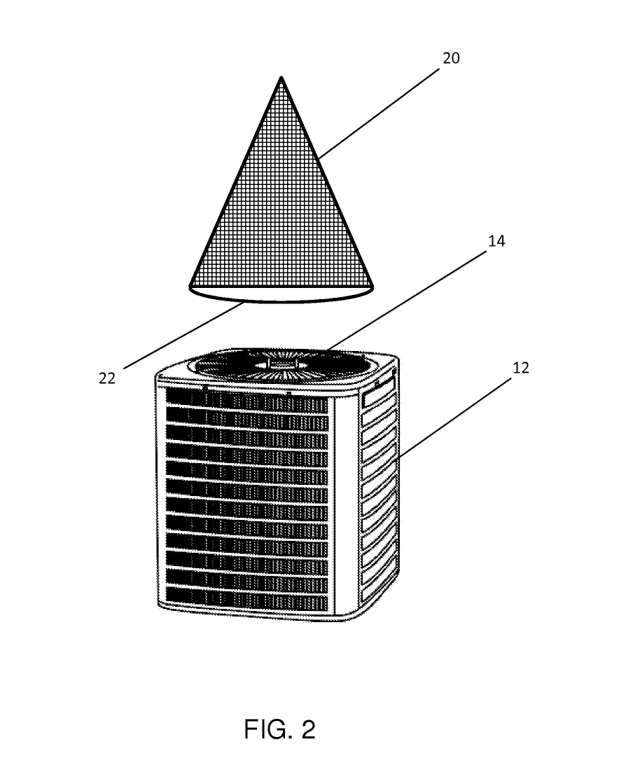

With reference to the attached figures, FIG. 2 is an exploded perspective of a conical mesh cover 20 and an A/C unit 12 prior to attachment over the exhaust fan 14 according to an embodiment of the invention. As shown the lower base circumference 22 of the cover 20 is sized to cover the exhaust fan 14.

A conical mesh cover 20 is provided as a flat sheet of mesh material. Mesh materials operative herein illustratively include plastic, galvanized steel, and aluminum alloys. Custom installation of the cover 20 is readily accomplished with cable ties or twisted wire.

A process of protecting an exhaust fan from debris infiltration includes forming the cone 20 by bringing together edges of the mesh material to form a cone shape and using ties or wire to retain the shape of the cone 20. It is appreciated that the cone is readily trimmed to remove excess as needed with shears. The base 22 of the cone 20 is readily secured to a housing of the A/C unit surround the exhaust fan 14 with resort to adhesive mounts to the A/C unit 12, the adhesive mounts defining an anchor point for a cable tie or wire that simultaneously engages the base 22 of the cone 20. Adhesive cable time mounts are commercially available including those from 3M under part number CTB1XBKA-C. Due to the open area and conical shape of the cover 20, an inventive device limits wind damage and clogging by debris, respectively.

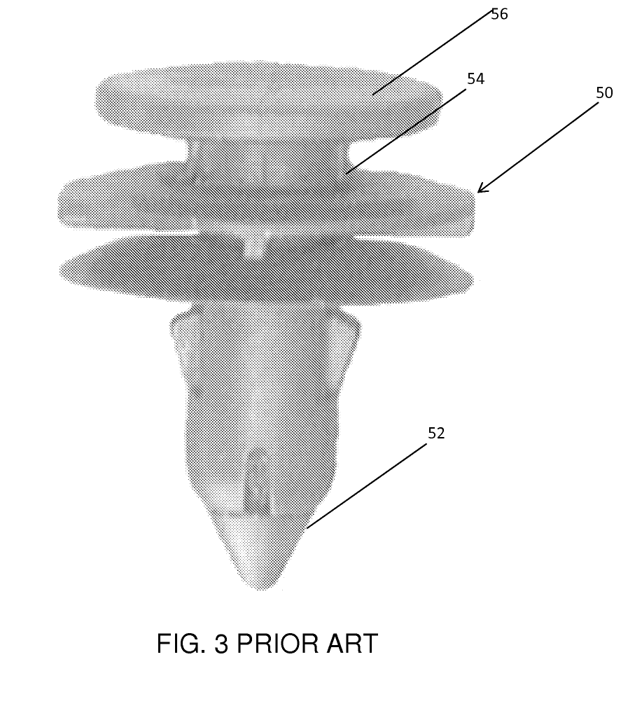

An alternative fastener to retain the shape of the cone 20, secure the cone 20 to the A/C unit 12, or both is a plunger—type retainer commonly used to secure automotive trim. Exemplary of these plunger-type retainers is a door trim panel retainer Jeep Grand Cherokee 6505539-AA and shown in prior art FIG. 3 generally at 50. In operation, the retainer 50 shaft 52 is passed through a first opening in the mesh and a second opening in the mesh intended to be bound together and the barrel 54 of the retainer 50 is engaged to create a flair by pushing the cap 56 downward relative to the shaft 52. It is noted that this is readily accomplished without resort to tools in particular embodiments. A similar operation is employed to join the cone 20 to the A/C unit 12.

The foregoing description is illustrative of particular embodiments of the invention, but is not meant to be a limitation upon the practice thereof. The following claims, including all equivalents thereof, are intended to define the scope of the invention.

1. An air conditioning cover comprising:
a mesh material configured as a cone, said cone having a lower base circumference that is designed to cover an exhaust fan opening of an A/C unit.

2. The cover of claim 1 wherein said cover is attached to said A/C unit with at least one fastener of bungee cords, an elastic band, an adjustable band clamp, snap connectors, a plunger-type retainer, or a combination thereof.

3. The cover of claim 1 wherein said cover is attached to said A/C unit with cable ties or twisted wire.

4. The cover of claim 1 wherein said cover is attached to said A/C unit with plunger-type retainers.

5. The cover of claim 1 wherein said mesh is formed from metal or plastic.

6. An air conditioning cover comprising:
a breathable material on a frame configured as a cone, said cone having a lower base circumference that is designed to cover an exhaust fan opening of an A/C unit.

7. The cover of claim 6 wherein said cover is attached to said A/C unit with at least one fastener of bungee cords, an elastic band, an adjustable band clamp, snap connectors, plunger-type retainers, or a combination thereof.

8. The cover of claim 6 wherein said cover is attached to said A/C unit with cable ties or twisted wire.

9. The cover of claim 6 wherein said cover is attached to said A/C unit with plunger-type retainers.

10. The cover of claim 6 wherein said mesh is formed from metal or plastic.

11. A process of protecting an exhaust fan from debris infiltration comprising:
providing an end-user with a flat sheet of a mesh material;
forming a cone from the mesh material;
providing instruction how to use fasteners to retain the shape of said cone; and
coupling said cone to a housing around the exhaust fan.

12. The process of claim 11 further comprising trimming said cone prior to joining said cone to said housing.
